(19) United States
(12) Patent Application Publication
(10) Pub. No.: US 2016/0381276 A1
(43) Pub. Date: Dec. 29, 2016

(54) METHOD AND USER TERMINAL FOR CAPTURING VIDEO FRAME

(71) Applicant: Xiaomi Inc., Beijing (CN)

(72) Inventors: Feiyun Li, Beijing (CN); Qiang Fu, Beijing (CN); Enxing Hou, Beijing (CN)

(21) Appl. No.: 15/007,225

(22) Filed: Jan. 27, 2016

(30) Foreign Application Priority Data
Jun. 29, 2015 (CN) 201510369698.9

(51) Int. Cl. H04N 5/232; G06F 3/0488; G06F 3/0484

(52) U.S. Cl. CPC H04N 5/23206; G06F 3/04842; G06F 3/0488

(57) ABSTRACT

A method and a user terminal for capturing a video frame are provided. The method includes: receiving a first user operation for capturing a video frame in a video content displayed on the user terminal; generating a first request according to the first user operation, wherein the first request comprises a time stamp and is configured to request an image or a video corresponding to the time stamp from a photographic device generating the video content; sending the first request to the photographic device; and obtaining the image or the video corresponding to the time stamp from the photographic device, wherein a resolution of the image or the video corresponding to the time stamp is higher than a resolution of the video content displayed on the user terminal.

### CROSS-REFERENCE TO RELATED APPLICATIONS

This application is based upon and claims priority to Chinese Patent Application Serial No. 201510369698.9, filed on Jun. 29, 2015, the entire contents of which are incorporated herein by reference.

### TECHNICAL FIELD

The present disclosure relates to a field of video service, and more particularly, to a method for capturing a video frame and the user terminal thereof.

### BACKGROUND

More and more photographic devices (such as a camera, a camera device, etc.) are provided with a communicating module connectable to a network. Thus, the user terminal may establish a communication connection with the photographic device via the network and the video content in the photographic device may be viewed remotely via the user terminal at any time, thus bringing convenience to the user.

### SUMMARY

Embodiments of the present disclosure provide a method for capturing a video frame and the user terminal thereof.

According to a first aspect of embodiments of the present disclosure, a method for capturing a video frame in a user terminal is provided. The method includes: receiving a first user operation for capturing a video frame in a video content displayed on the user terminal; generating a first request according to the first user operation, wherein the first request comprises a time stamp and is configured to request an image or a video corresponding to the time stamp from a photographic device generating the video content; sending the first request to the photographic device; and obtaining the image or the video corresponding to the time stamp from the photographic device, wherein a resolution of the image or the video corresponding to the time stamp is higher than a resolution of the video content displayed on the user terminal.

According to a second aspect of embodiments of the present disclosure, a method for providing a video frame in a photographic device is provided. The method includes: receiving a first request from a user terminal displaying a video content, wherein the first request comprises a time stamp and is configured to request an image or a video corresponding to the time stamp from the photographic device generating the video content; extracting the image or the video corresponding to the time stamp; and providing the image or the video corresponding to the time stamp to the user terminal, wherein a resolution of the image or the video corresponding to the time stamp is higher than a resolution of the video content displayed on the user terminal.

According to a third aspect of embodiments of the present disclosure, a user terminal is provided. The user terminal includes: a processor; a memory for storing instructions executable by the processor; wherein the processor is configured to: receive a first user operation for capturing a video frame in a video content displayed on the user terminal; generate a first request according to the first user operation, wherein the first request comprises a time stamp and is configured to request an image or a video corresponding to the time stamp from a photographic device generating the video content; send the first request to the photographic device; and obtain the image or the video corresponding to the time stamp from the photographic device, wherein a resolution of the image or the video corresponding to the time stamp is higher than a resolution of the video content displayed on the user terminal.

According to a fourth aspect of embodiments of the present disclosure, a photographic device is provided. The photographic device includes: a processor; a memory for storing instructions executable by the processor; wherein the processor is configured to: receive a first request from a user terminal displaying a video content, wherein the first request comprises a time stamp and is configured to request an image or a video corresponding to the time stamp from the photographic device generating the video content; extract the image or the video corresponding to the time stamp; and provide the image or the video corresponding to the time stamp to the user terminal, wherein a resolution of the image or the video corresponding to the time stamp is higher than a resolution of the video content displayed on the user terminal.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate embodiments consistent with the disclosure and, together with the description, serve to explain the principles of the disclosure.

FIG. 1 is a schematic diagram of an implement environment according to an exemplary embodiment;

FIG. 2 is a flow chart showing a method for capturing a video frame according to an exemplary embodiment;

FIG. 3 is a flow chart showing a method for capturing a video frame according to another exemplary embodiment;

FIG. 4 is a schematic diagram of an interface of a user terminal when the method provided in the embodiment shown in FIG. 2 or 3 is implemented;

FIG. 5 is a flow chart showing a method for providing a video frame according to an exemplary embodiment;

FIG. 6 is a flow chart showing a method for providing a video frame according to another exemplary embodiment;

FIG. 7 is a schematic diagram showing a signaling interaction between a user terminal and a photographic device according to an exemplary embodiment of the present disclosure;

FIG. 8 is a block diagram of an apparatus for capturing a video frame according to an exemplary embodiment;

FIG. 9 is a block diagram of an apparatus for capturing a video frame according to another exemplary embodiment;

FIGS. 10a-10b are block diagrams of an apparatus for capturing a video frame according to another exemplary embodiment;

FIGS. 11a-11b are block diagrams of an apparatus for capturing a video frame according to another exemplary embodiment;

FIG. 12 is a block diagram of an apparatus for providing a video frame according to an exemplary embodiment;

FIG. 13 is a block diagram of an apparatus for providing a video frame according to another exemplary embodiment;

FIG. 14 is a block diagram of an apparatus for providing a video frame according to another exemplary embodiment;

FIGS. 15a-15b are block diagrams of an apparatus for providing a video frame according to another exemplary embodiment; and

FIG. 16 is a block diagram of a user terminal for capturing a video frame according to an exemplary embodiment.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims.

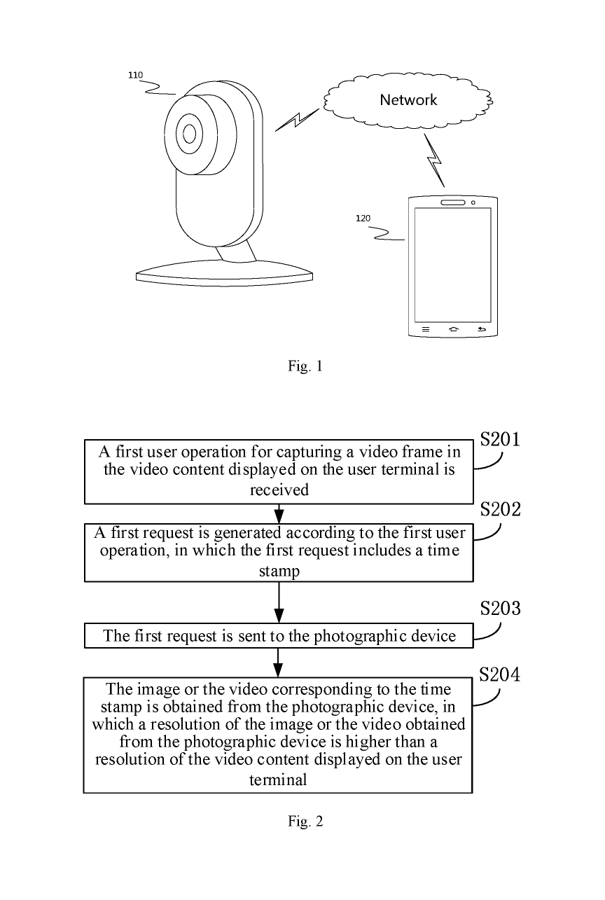

FIG. 1 is a schematic diagram of an implement environment according to an exemplary embodiment. As shown in FIG. 1, the implement environment may include a photographic device 110 and a user terminal 120. The photographic device 110 may connect to the user terminal 120 via a network, and may communicate with the user terminal 120 via the network. The network may include, but is not limited to, WiFi (Wireless Fidelity), 2G (the 2^{nd} generation wireless telephone technology), 3G (the 3^{rd} generation wireless telephone technology), 4G (the 4^{th} generation wireless telephone technology) network, etc.

The photographic device 110 may be an intelligent camera device or an intelligent camera with a storage function and a processing function. The user terminal 120 may directly obtain a video content generated by the intelligent camera device or the intelligent camera from the intelligent camera device or the intelligent camera. Or, the photographic device 110 may include a camera and a server connected to the camera (via wireless or wired connection), and the server is configured to store and process a video content generated by the camera. The user terminal 120 may obtain the video content generated by the camera from the server. Thus, the user operations on the camera may be simplified and the requirement for the storage ability and the processing ability of the camera is reduced. In FIG. 1, the photographic device 110 is illustrated by taking the intelligent camera as an example.

The user terminal 120 may be an intelligent phone, a tablet computer, a PC, a laptop, etc. The user terminal 120 may view the video content generated by the photographic device 110 via the network, such that the remote video monitoring may be implemented. In FIG. 1, the user terminal 120 is illustrated by taking the intelligent phone as an example.

FIG. 2 is a flow chart showing a method for capturing a video frame according to an exemplary embodiment. The method may be applied in a user terminal, such as the user terminal 120 shown in FIG. 1. As shown in FIG. 2, the method includes following steps.

In step S201, a first user operation for capturing a video frame in the video content displayed on the user terminal is received.

The first user operation may be used for indicating a user's intention of capturing an image or a video (the image or the video can be collectively called as a “video frame”) in the video content currently displayed on the user terminal. The first user operation may include an operation for capturing an image and an operation for capturing a video input by a user. For example, when the user views the video content obtained from the photographic device and displayed on the user terminal, if the user is interested in a picture at one moment or in a period in the video content, the user may perform the operation for capturing the image via an interactive interface of the user terminal for indicating the intention of capturing the image corresponding to the moment or the period, or the user may perform the operation for capturing the video frame via the interactive interface of the user terminal for indicating the intention of capturing the video corresponding to the moment or the period. Then, the user terminal may receive the first user operation for capturing the video frame.

In step S202, a first request for capturing the video frame is generated according to the first user operation, in which the first request includes a time stamp and is configured to request an image or a video corresponding to the time stamp from a photographic device generating the video content.

For example, the time stamp may be a time when the first user operation is received or a time which is defined by the user through the interactive interface of the user terminal. If the time stamp is the latter one, the user terminal receives the time which is defined by the user before generating the first request for capturing the video frame, and then the time which is defined by the user is used as the time stamp and is included in the first request for capturing the video frame.

In step S203, the first request is sent to the photographic device.

In step S204, the image or the video corresponding to the time stamp is obtained from the photographic device, in which a resolution of the image or the video obtained from the photographic device is higher than a resolution of the video content displayed on the user terminal.

In one example, the image corresponding to the time stamp may include the image just at the moment indicated by the time stamp. For example, the time stamp is 20:30, the image corresponding to the time stamp may include the image at the moment 20:30.

Alternatively, the image corresponding to the time stamp may include the image just at the moment indicated by the time stamp, and images respectively at some moments before and/or after the moment indicated by the time stamp by several time units. For example, if the time stamp is 20:30, the images corresponding to the time stamp may include the image at the moment 20:30, an image at the moment 20:28, an image at the moment 20:29, and an image at the moment 20:31, and so on. In this way, the photographic device may provide some images to the user for selecting. It can be avoided that the image which the user is interested in cannot be captured due to the untimely first user operation for obtaining the video frame.

In one example, the video corresponding to the time stamp may include one or more of: a video started from the time stamp and ended at a time which is some units (such as, 10 units) of time later than the time stamp; a video started from a time which is some units (such as, 10 units) of time earlier than the time stamp and ended at the time stamp; a video started from a time which is some units (such as, 5 units) of time earlier than the time stamp and ended at a time which is some units (such as, 5 units) of time later than time stamp, and so on.

As described with reference to FIG. 1, the photographic device may be an intelligent camera device or an intelligent camera with the storage function and the processing function. In this situation, the user terminal may directly obtain the image or the video corresponding to the time stamp from the intelligent camera device or the intelligent camera.

Alternatively, the photographic device may include a camera and a server connected to the camera, and the server is configured to store and process the video content photographed by the camera. In this situation, the user terminal may obtain the image or the video corresponding to the time stamp from the server.

The video content currently displayed on the user terminal is generated by the photographic device, i.e. the video content currently displayed on the user terminal is provided by the photographic device. On the photographic device, the resolution of the video content provided to the user terminal may be recorded. After receiving the first request for capturing the video frame from the user terminal, the photographic device may provide the image or the video corresponding to the time stamp and with a resolution higher than the recorded resolution.

Alternatively, the user terminal may add the resolution of the video content currently displayed into the first request for capturing the video frame. After receiving the first request for capturing the video frame, the photographic device may determine the resolution of the video content currently displayed on the user terminal from the first request for capturing the video frame. And then the photographic device provides the image or the video corresponding to the time stamp and with a resolution higher than the resolution determined from the first request.

In conclusion, with the method for capturing a video content, by sending the first request for capturing the video frame to the photographic device, the user terminal may obtain the image or the video corresponding to the time stamp from the photographic device, and the resolution of the image or the video from the photographic device is higher than the resolution of the video content currently displayed on the user terminal, such that the effect of obtaining image or the video with a higher resolution at the moment or in the period which the user is interested in may be achieved when the user views the video content with a lower resolution.

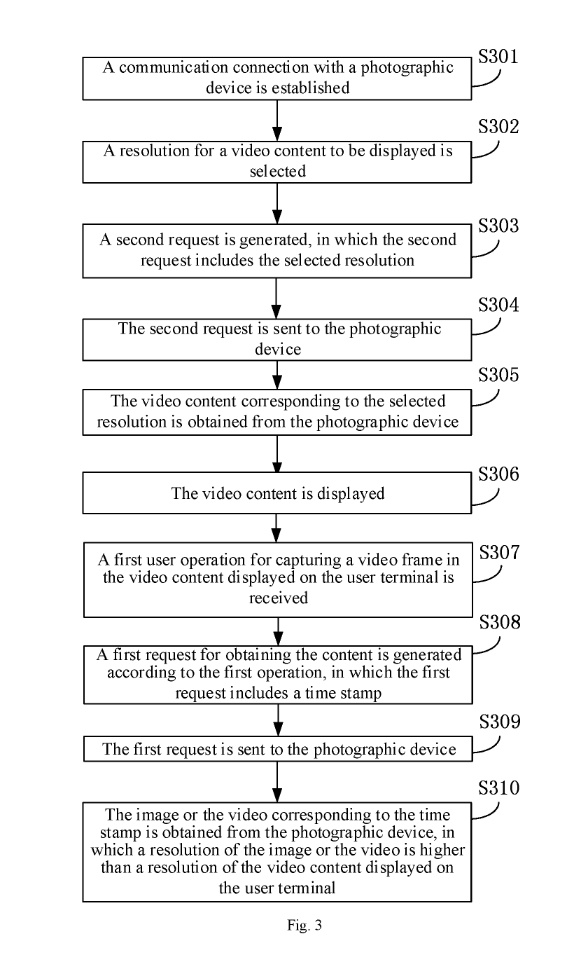

FIG. 3 is a flow chart showing a method for capturing a video content according to another exemplary embodiment. The method may be applied in a user terminal, such as the user terminal 120 shown in FIG. 1. As shown in FIG. 3, the method may include following steps.

In step S301, a communication connection with a photographic device is established. For example, the user terminal may establish the communication connection with the photographic device via a wireless or wired technology, such as WiFi, 2G, 3G, or 4G ect.

In step S302, a resolution for a video content to be displayed is selected. For example, the source video content photographed by the photographic device may have a high resolution. For example, the high resolution may be 1080p. The selected resolution may be lower than the resolution of the source video content photographed by the photographic device. For example, the selected resolution may be a standard resolution, such as 720p.

The resolution for the video content to be displayed may be selected in many ways. For example, in a first way, the user may perform a second user operation for selecting the resolution on an interactive interface provided by the user terminal, in which the second user operation for selecting the resolution may be used for indicating the selected resolution for the video content to be displayed. The user terminal may receive the second user operation for selecting the resolution, and select the resolution for the video content to be displayed according to the second user operation for selecting the resolution. In this way, the user may actively select any lower resolution (such as the standard resolution 720p) as the resolution for the video content to be displayed, thus meeting the user's actual requirement.

In a second way, the user terminal may detect its own current communication mode, and select the resolution for the video content to be displayed according to the current communication mode. For example, if the user terminal detects that the current communication mode is a communication mode consuming the user's network traffic such as 2G, 3G, or 4G etc., the user terminal may automatically select a lower resolution (such as the standard resolution 720p) as the resolution for the video content to be displayed without any operation from the user, which is simple and convenient.

In step S303, a second request is generated, in which the second request includes the selected resolution and is configured to request the video content corresponding to the selected resolution from the photographic device.

In step S304, the second request is sent to the photographic device.

After receiving the second request for displaying the video, the photographic device may determine the resolution selected by the user terminal from the second request, and then the video content corresponding to the resolution selected by the user terminal is provided to the user terminal.

In step S305, the video content corresponding to the selected resolution is obtained from the photographic device.

As described with reference to FIG. 1, the photographic device may be an intelligent camera device or an intelligent camera with the storage function and the processing function. In this situation, the user terminal may directly obtain the video content corresponding to the selected resolution from the intelligent camera device or the intelligent camera.

Alternatively, the photographic device may include a camera and a server connected to the camera, and the server is configured to store and process the video content photographed by the camera. In this situation, the user terminal may obtain the video content corresponding to the resolution selected by the user terminal from the server.

In step S306, the video content is displayed. At this time, the video content displayed on the user terminal is the video content corresponding to the resolution selected by the user terminal.

By permitting the user terminal to display the video content with a resolution lower than that of the source video content photographed by the photographic device, the network traffic of the user terminal may be reduced and the cost may be saved, thus improving the transmission speed of the video.

In step S307, a first user operation for capturing a video frame in the video content displayed on the user terminal is received.

In step S308, a first request for capturing the video frame is generated according to the first user operation, in which the first request includes a time stamp and is configured to request an image or a video corresponding to the time stamp from a photographic device generating the video content.

In step S309, the first request is sent to the photographic device.

In step S310, the image or the video corresponding to the time stamp is obtained from the photographic device, in which a resolution of the image or the video is higher than a resolution of the video content displayed on the user terminal.

The steps S307-310 are the same to the steps S201-S204, which are not described herein.

In step S204 or S310, the user terminal may obtain the image or the video corresponding to the time stamp from the photographic device in many ways. For example, in a first way, the user terminal may send an address to the photographic device, such that the photographic device uploads the image or the video corresponding to the time stamp to the address. The address may be an address such as URL (Uniform Resource Locator). And then, the user terminal may receive a message indicating that the image or the video is successfully uploaded from the photographic device. The message may indicate that the image or the video corresponding to the time stamp is successfully uploaded to the address by the photographic device. And then, the user terminal may obtain (such as, download) the image or the video corresponding to the time stamp from the address. By this way, the user terminal may define any address, which is helpful to ensure the communication safety.

In a second way, the user terminal may receive a message indicating an image or a video is successfully uploaded and an address of the image or the video, in which the message may indicate the image or the video corresponding to the time stamp is successfully uploaded to the address by the photographic device, and the address is used for indicating a position of the image or the video uploaded by the photographic device. Then, the user terminal may obtain (such as, download) the image or the video corresponding to the time stamp from the address. By this way, the procedure of obtaining the image or the video by the user terminal is simplified, such that the user terminal may obtain the image or the video corresponding to the time stamp more effectively and quickly.

In the present disclosure, the message indicating the image or the video is successfully uploaded may be in a form of a short message, a notification message or a voice message, etc.

In conclusion, with the method for capturing a video content, since the user terminal displays the video content with the resolution lower than the resolution of the source video content photographed by the photographic device, the network traffic of the user terminal is reduced, and the cost is saved, also the transmission speed of the video is improved. Further, by sending the first request for capturing the video frame to the photographic device, the user terminal may obtain the image or the video corresponding to the time stamp from the photographic device. And the resolution of the image or the video from the photographic device is higher than that of the video content currently displayed on the user terminal, such that the effect of obtaining the image or the video with a higher resolution at the moment or in the period which the user is interested in may be achieved when the user views the video content with a lower resolution.

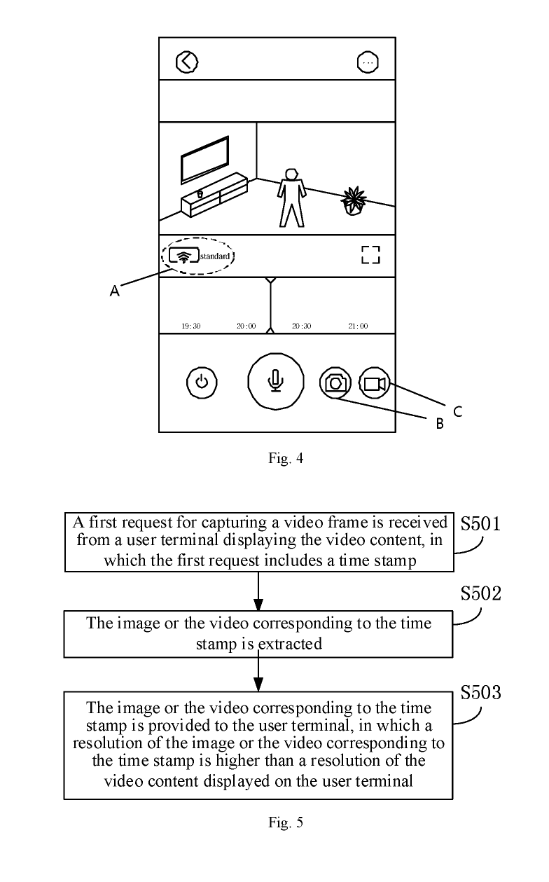

FIG. 4 is a schematic diagram of an interface of a user terminal when the method provided in the embodiment shown in FIG. 2 or 3 is implemented. For example, as shown in FIG. 4, the user may perform the second user operation for selecting the resolution for the video to be displayed in a field A of the interface of the user terminal. For example, the user selects the “standard” resolution (i.e., 720p) as the resolution for the video to be displayed, so as to reduce the network traffic of the user terminal and improve the transmission speed of the video. After the user selects the “standard” resolution, the user terminal may display the video content corresponding to the standard resolution and provided by the photographic device. During the display of the video content, the user may perform the operation for capturing the image by clicking a filed B on the interface of the user terminal. And then, the user terminal may obtain a corresponding high-definition image. Or, the user may perform the operation for capturing the video by clicking a filed C on the interface of the user terminal. And then, the user terminal may obtain a corresponding high-definition video.

Alternatively, after obtaining image or the video from the photographic device, the user terminal may display the image or the video. Thus, it is convenient for the user to view and to filter, delete, edit, or share the image or the video.

FIG. 5 is a flow chart showing a method for providing a video content according to an exemplary embodiment. The method may be applied in a photographic device, such as the photographic device 110 shown in FIG. 1. As shown in FIG. 5, the method may include following steps.

In step S501, a first request for capturing a video frame is received from a user terminal displaying the video content, in which the first request includes a time stamp and is configured to request an image or a video corresponding to the time stamp from the photographic device generating the video content.

In step S502, the image or the video corresponding to the time stamp is extracted. For example, the photographic device may extract the time stamp from the first request for capturing the video frame firstly, and then extracts the image or the video corresponding to the time stamp from the video content photographed.

In step S503, the image or the video corresponding to the time stamp is provided to the user terminal, in which a resolution of the image or the video from the photographic device is higher than a resolution of the video content currently displayed on the user terminal.

In an example, the image corresponding to the time stamp may include the image just at the moment indicated by the time stamp. For example, the time stamp is 20:30, the image corresponding to the time stamp may include the image at the moment 20:30.

Alternatively, the image corresponding to the time stamp may include the image just at the moment indicated by the time stamp, and images respectively at some moments before and/or after the moment indicated by the time stamp by several time units. For example, if the time stamp is 20:30, the images corresponding to the time stamp may include the image at the moment 20:30, an image at the moment 20:28, an image at the moment 20:29, and an image at the moment 20:31, and so on. In this way, the photographic device may provide some images to the user for selecting. It can be avoided that the image the user is interested in cannot be captured due to the untimely first user operation for capturing the video frame.

In one example, the video corresponding to the time stamp may include one or more of: a video started from the time stamp and ended at a time which is some units (such as, 10 units) of time later than the time stamp; a video started from a time which is some units (such as, 10 units) of time earlier than the time stamp and ended at the time stamp; a video started from a time which is some units (such as, 5 units) of time earlier than the time stamp and ended at a time which is some units (such as, 5 units) of time later than time stamp, and so on.

As described with reference to FIG. 1, the photographic device may be an intelligent camera device or an intelligent camera with the storage function and the processing function. In this situation, the intelligent camera device or the intelligent camera may directly receive the first request for capturing the video frame from the user terminal, directly extract the image or the video corresponding to the time stamp from the video content photographed, and directly provide the image or the video corresponding to the time stamp to the user terminal.

Alternatively, the photographic device may include a camera and a server connected to the camera, and the server is configured to store and process the video content photographed by the camera. In this situation, the photographic device may provide the image or the video corresponding to the time stamp in many ways.

For example, in a first way, the camera may directly receive the first request for capturing the video frame from the user terminal, and then may transfer the first request to the server. Then, the server may extract the image or the video corresponding to the time stamp from the video content photographed by the camera. The server then sends the image or the video corresponding to the time stamp to the user terminal via the camera or via itself directly.

For example, in a second way, the server may directly receive the first request for capturing the video frame from the user terminal, and extracts the image or the video corresponding to the time stamp from the video content photographed by the camera. The server then sends the image or the video corresponding to the time stamp to the user terminal via the camera or via itself directly.

The way of providing the image or the video corresponding to the time stamp to the user terminal by the photographic device is not limited to the above two ways.

When providing the image or the video corresponding to the time stamp to the user terminal, alternatively, the photographic device may directly send the image or the video corresponding to the time stamp and extracted from the source video content photographed by the photographic device to the user terminal. Because, the resolution of the source video content photographed by the photographic device is the highest one in the resolutions of the video contents that the photographic device may provide. The resolution of the video content currently displayed on the user terminal is lower than the resolution of the source video content photographed by the photographic device, such that it is possible to make sure that the resolution of the image or the video provided to the user terminal is higher than that of the video content currently displayed on the user terminal.

Alternatively, the photographic device may convert the resolution of the image or the video corresponding to the time stamp and extracted from the source video content photographed by the photographic device (the operation may be performed in the intelligent camera device or the intelligent camera, or may be performed in the server in the photographic device), so as to decrease the resolution of the image or the video. However, the decreased resolution of the image or the video is still higher than the resolution of the video content currently displayed on the user terminal. And then, the image or the video corresponding to the time stamp and with the converted resolution is provided to the user terminal. In this way, the user may obtain the image or the video corresponding to the time stamp and with a higher resolution, as well as the network traffic of the user terminal is reduced to some extent, the cost is saved, and the transmission speed of the image or the video corresponding to the time stamp is improved.

In conclusion, with the method for providing a video content, by sending the first request for capturing the video frame to the photographic device, the user terminal may obtain the image or the video corresponding to the time stamp from the photographic device, and the resolution of the image or the video from the photographic device is higher than the resolution of the video content currently displayed on the user terminal, such that the effect of obtaining image or the video with a higher resolution at the moment or in the period which the user is interested in may be achieved when the user views the video content with a lower resolution.

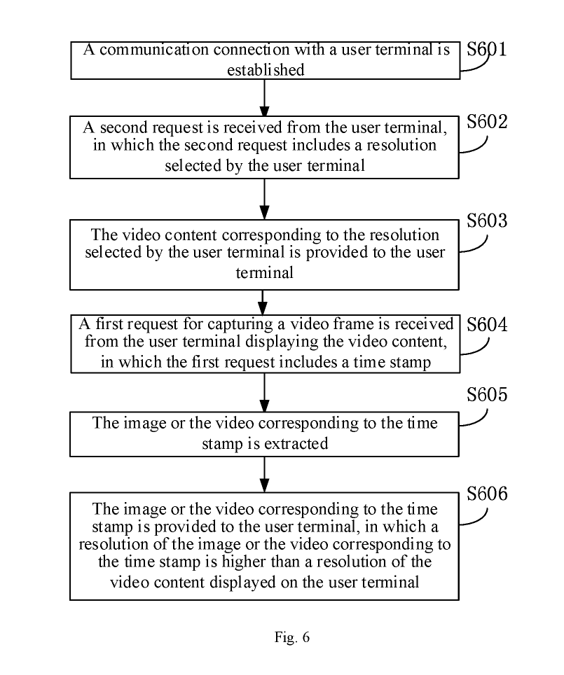

FIG. 6 is a flow chart showing a method for providing a video content according to another exemplary embodiment. The method may be applied in a photographic device, such as the photographic device 110 shown in FIG. 1. As shown in FIG. 6, the method may include following steps.

In step S601, a communication connection with a user terminal is established. For example, the photographic device may establish the communication connection with the user terminal via a wireless or wired technology, such as WiFi, 2G, 3G or 4G, ect.

In step S602, a second request is received from the user terminal, in which the second request includes a resolution selected by the user terminal and is configured to request the video content corresponding to the resolution selected by the user terminal from the photographic device, and the resolution selected by the user terminal is lower than a resolution of the source video content photographed by the photographic device.

In step S603, the video content corresponding to the resolution selected by the user terminal is provided to the user terminal.

For example, the source video content photographed by the photographic device may have a high resolution. For example, the high resolution may be 1080p. The photographic device may store the video content with the high resolution at the time when the video content with the high resolution is photographed. Once the photographic device receives the second request which includes the resolution selected by the user terminal from the user terminal, the photographic device may convert the resolution of the video content photographed by itself to conform to the resolution selected by the user terminal. For example, the resolution selected by the user terminal is a standard resolution, such as 720p. The photographic device may compress the photographed high-definition video with a resolution 1080p, so as to convert the high-definition resolution into the resolution selected by the user terminal. And then the video content corresponding to the resolution selected by the user terminal is provided to the user terminal. In this way, the network traffic of the user terminal is reduced and the transmission speed of the video is improved.

As described with reference to FIG. 1, the photographic device may be an intelligent camera device or an intelligent camera with the storage function and the processing function. In this situation, the intelligent camera device or an intelligent camera compresses the video. Alternatively, the photographic device may include a camera and a server connected to the camera, and the server is configured to store and process the video content photographed by the camera. In this situation, the server compresses the video.

Alternatively, the photographic device always stores the video content with the high resolution, although it provides the video content with a standard resolution to the user terminal.

In step S604, a first request for capturing a video frame is received from the user terminal displaying the video content, in which the first request includes a time stamp and is configured to request an image or a video corresponding to the time stamp from the photographic device generating the video content.

In step S605, the image or the video corresponding to the time stamp is extracted. For example, the photographic device may extract the image or the video corresponding to the time stamp from the stored video content with high-definition resolution.

In step S606, the image or the video corresponding to the time stamp is provided to the user terminal, in which a resolution of the image or the video corresponding to the time stamp from the photographic device is higher than a resolution of the video content displayed on the user terminal (i.e., the resolution selected by the user terminal).

The steps S604-S606 are the same to the steps S501-S503, which are not described herein.

In step S503 or step S606, the photographic device may provide the image or the video corresponding to the time stamp to the user terminal in many ways. For example, in a first way, the photographic device receives an address from the user terminal, and then uploads the image or the video corresponding to the time stamp to the address. After the image or the video corresponding to the time stamp is successfully uploaded, a message indicating that the image or the video is successfully uploaded is sent to the user terminal.

In a second way, the photographic device uploads the image or the video corresponding to the time stamp to an address, in which the address is used for indicating a position of the image or the video corresponding to the time stamp and uploaded by the photographic device. After the image or the video corresponding to the time stamp is successfully uploaded, a message indicating that the image or the video is successfully uploaded and the address are sent to the user terminal, such that the user terminal may obtain the image or the video corresponding to the time stamp from the address.

In the present disclosure, the message indicating the image or the video is successfully uploaded may indicate that the image or the video corresponding to the time stamp is successfully uploaded to the address by the photographic device, and the message indicating the image or the video is successfully uploaded may be in a form of a short message, a notification message or a voice message, etc.

In conclusion, with the method for providing a video content, since photographic device provides the video content with the resolution lower than the resolution of the source video content photographed by the photographic device to the user terminal, the network traffic of the user terminal is reduced, and the cost is saved, also the transmission speed of the video is improved. Further, by sending the first request for capturing the video frame to the photographic device, the user terminal may obtain the image or the video corresponding to the time stamp from the photographic device. And the resolution of the image or the video corresponding to the time stamp from the photographic device is higher than that of the video content currently displayed on the user terminal, such that the effect of obtaining the image or the video with a higher resolution at the moment or in the period which the user is interested in may be achieved, when the user views the video content with a lower resolution.

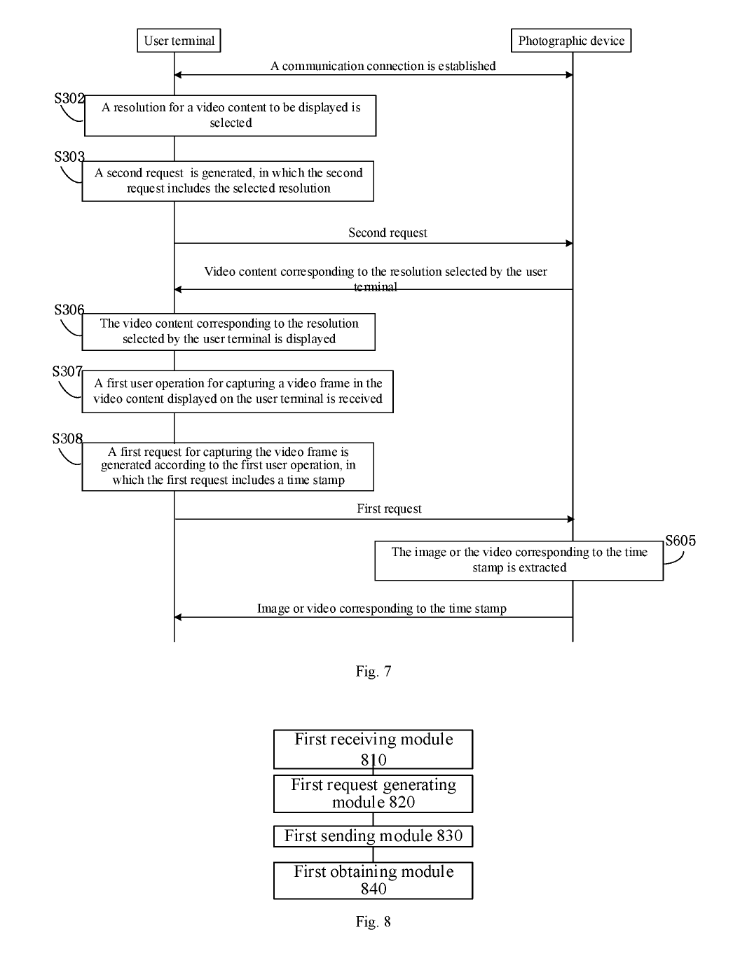

FIG. 7 is a schematic diagram showing a signaling interaction between the user terminal and the photographic device according to an exemplary embodiment of the present disclosure. The user terminal is the user terminal 120 shown in FIG. 1. The photographic device is the photographic device 110 shown in FIG. 1. FIG. 7 refers to a part or all of the steps in one or more methods described above which are applied in the user terminal or the photographic device, such that the signaling interaction is not described herein.

FIG. 8 is a block diagram of an apparatus for capturing a video content according to an exemplary embodiment. The apparatus may be configured in a user terminal, such as the user terminal 120 shown in FIG. 1. Referring to FIG. 8, the apparatus may include a first receiving module 810, configured to receive a first user operation for capturing a video frame in the video content displayed on the user terminal; a first request generating module 820, configured to generate a first request for capturing the video frame according to the first user operation, in which the first request includes a time stamp and is configured to request an image or a video corresponding to the time stamp from a photographic device generating the video content; a first sending module 830, configured to send the first request to the photographic device; and a first obtaining module 840, configured to obtain the image or the video corresponding to the time stamp from the photographic device, in which a resolution of the image or the video corresponding to the time stamp from the photographic device is higher than a resolution of the video content displayed on the user terminal.

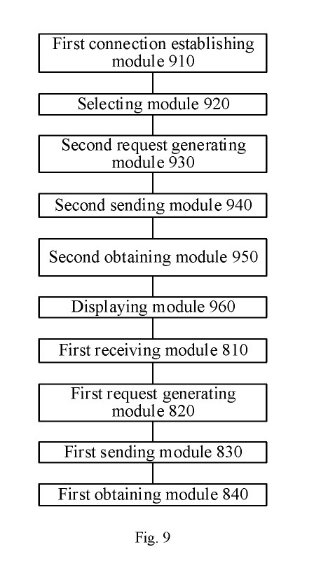

FIG. 9 is a block diagram of an apparatus for capturing a video content according to another exemplary embodiment. The apparatus may be configured in a user terminal, such as the user terminal 120 shown in FIG. 1. Referring to FIG. 9, the apparatus may further include a first connection establishing module 910, configured to establish a communication connection with the photographic device; a selecting module 920, configured to select a resolution for a video content to be displayed, in which the resolution selected is lower than a resolution of the source video content photographed by the photographic device; a second request generating module 930, configured to generate a second request for displaying a video, in which the second request includes the resolution selected and is configured to request the video content corresponding to the resolution selected from the photographic device; a second sending module 940, configured to send the second request to the photographic device; a second obtaining module 950, configured to obtain the video content corresponding to the resolution selected from the photographic device; and a displaying module 960, configured to display the video content.

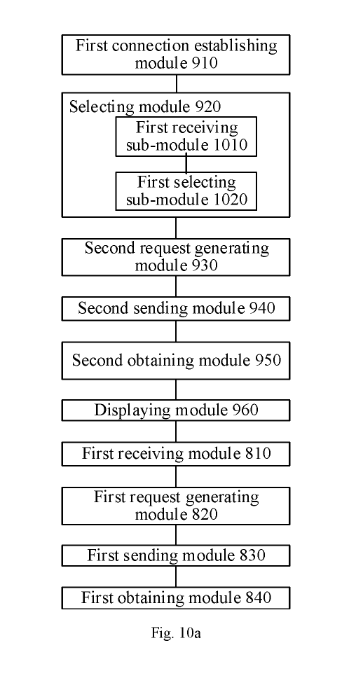

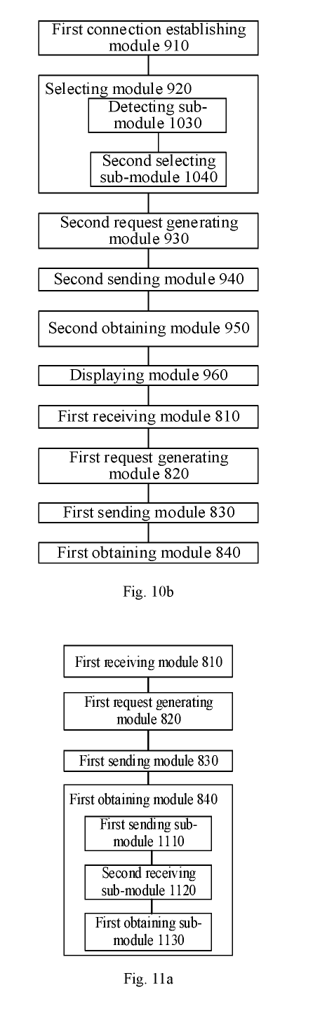

FIGS. 10a-10b are block diagrams of an apparatus for capturing a video content according to another exemplary embodiment. The apparatus may be configured in a user terminal, such as the user terminal 120 shown in FIG. 1. Referring to FIG. 10a, alternatively, the selecting module 920 may include a first receiving sub-module 1010, configured to receive a second user operation for selecting a resolution, in which the second user operation is configured to indicate the resolution for the video content to be displayed; and a first selecting sub-module 1020, configured to select the resolution for the video content to be displayed according to the second user operation.

Alternatively, referring to FIG. 10b, the selecting module 920 may include: a detecting sub-module 1030, configured to detect a communication mode of the user terminal; and a second selecting sub-module 1040, configured to select the resolution for the video content to be displayed according to the communication mode.

FIGS. 11a-11b are block diagrams of an apparatus for capturing a video content according to another exemplary embodiment. The apparatus may be configured in a user terminal, such as the user terminal 120 shown in FIG. 1. Referring to FIG. 11a, alternatively, the first obtaining module 840 may include: a first sending sub-module 1110, configured to send an address to the photographic device, such that the photographic device uploads the image or the video corresponding to the time stamp to the address; a second receiving sub-module 1120, configured to receive a message indicating that the image or the video is successfully uploaded from the photographic device; and a first obtaining sub-module 1130, configured to obtain the image or the video corresponding to the time stamp from the address.

Alternatively, referring to FIG. 11b, the first obtaining module 840 may include: a third receiving sub-module 1140, configured to receive a message indicating that an image or a video is successfully uploaded and an address from the photographic device, in which the address indicates a position of the image or the video uploaded by the photographic device; and a second obtaining sub-module 1150, configured to obtain the image or the video corresponding to the time stamp from the address.

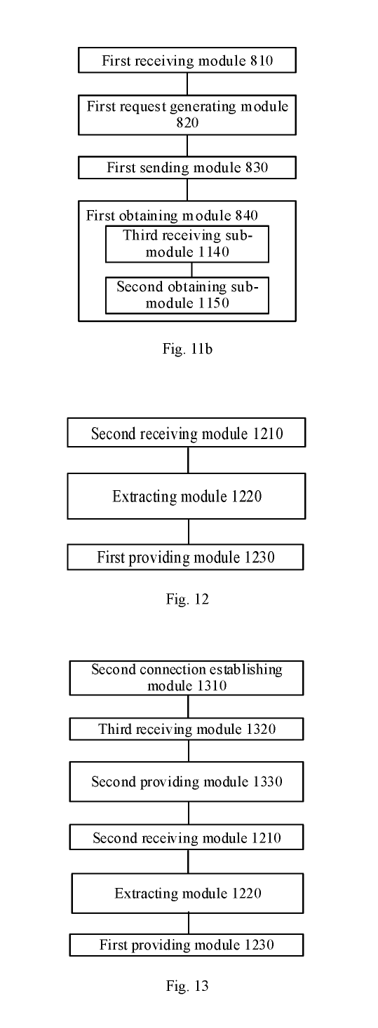

FIG. 12 is a block diagram of an apparatus for providing a video content according to an exemplary embodiment. The apparatus may be configured in a photographic device, such as the photographic device 110 shown in FIG. 1. Referring to FIG. 12, the apparatus may include: a second receiving module 1210, configured to receive a first request for capturing a video frame from a user terminal displaying the video content, in which the first request includes a time stamp and is configured to request an image or a video corresponding to the time stamp from the photographic device generating the video content; an extracting module 1220, configured to extract the image or the video corresponding to the time stamp; and a first providing module 1230, configured to provide the image or the video corresponding to the time stamp to the user terminal, in which a resolution of the image or the video corresponding to the time stamp from the photographic device is higher than a resolution of the video content displayed on the user terminal.

FIG. 13 is a block diagram of an apparatus for providing a video content according to another exemplary embodiment. The apparatus may be configured in a photographic device, such as the photographic device 110 shown in FIG. 1. Referring to FIG. 13, alternatively, the apparatus may further include: a second connection establishing module 1310, configured to establish a communication connection with the user terminal; a third receiving module 1320, configured to receive a second request from the user terminal, in which the second request includes a resolution selected by the user terminal and is configured to request the video content corresponding to the resolution selected by the user terminal from the photographic device, and the resolution selected by the user terminal is lower than a resolution of the source video content photographed by the photographic device; and a second providing module 1330, configured to provide the video content corresponding to the resolution selected by the user terminal to the user terminal.

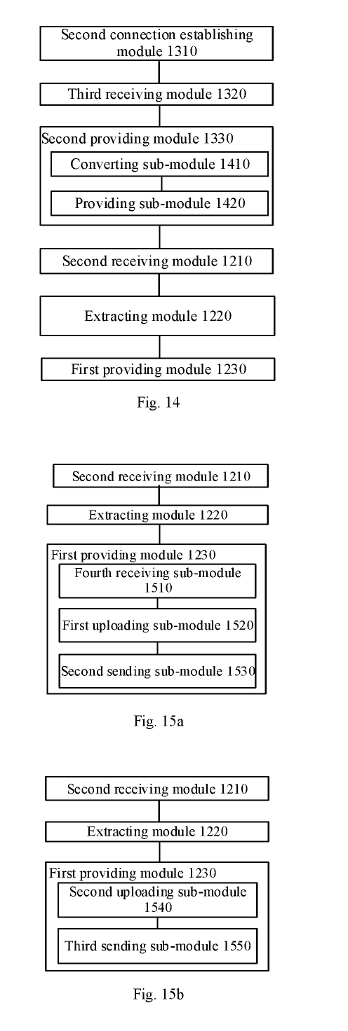

FIG. 14 is a block diagram of an apparatus for providing a video content according to another exemplary embodiment. The apparatus may be configured in a photographic device, such as the photographic device 110 shown in FIG. 1. Referring to FIG. 14, alternatively, the second providing module 1330 may include: a converting sub-module 1410, configured to convert the resolution of the source video content photographed by the photographic device so as to conform to the resolution selected by the user terminal; and a providing sub-module 1420, configured to provide the video content corresponding to the resolution selected by the user terminal to the user terminal.

FIGS. 15a-15b are block diagrams of an apparatus for providing a video content according to another exemplary embodiment. The apparatus may be configured in a photographic device, such as the photographic device 110 shown in FIG. 1. Referring to FIG. 15a, alternatively, the first providing module 1230 may include: a fourth receiving sub-module 1510, configured to receive an address from the user terminal; a first uploading sub-module 1520, configured to upload the image or the video corresponding to the time stamp to the address; and a second sending sub-module 1530, configured to send a message indicating that the image or the video is successfully uploaded to the user terminal.

Alternatively, referring to FIG. 15b, the first providing module 1230 may include: a second uploading sub-module 1540, configured to upload the image or the video corresponding to the time stamp to an address, in which the address indicates a position of the image or the video uploaded by the photographic device; and a third sending sub-module 1550, configured to send a message indicating that the image or the video is successfully uploaded and the address to the user terminal.

With respect to the apparatus in the above embodiments, the specific manners for performing operations for individual modules therein have been described in detail in the embodiments regarding the methods, which will not be elaborated herein.

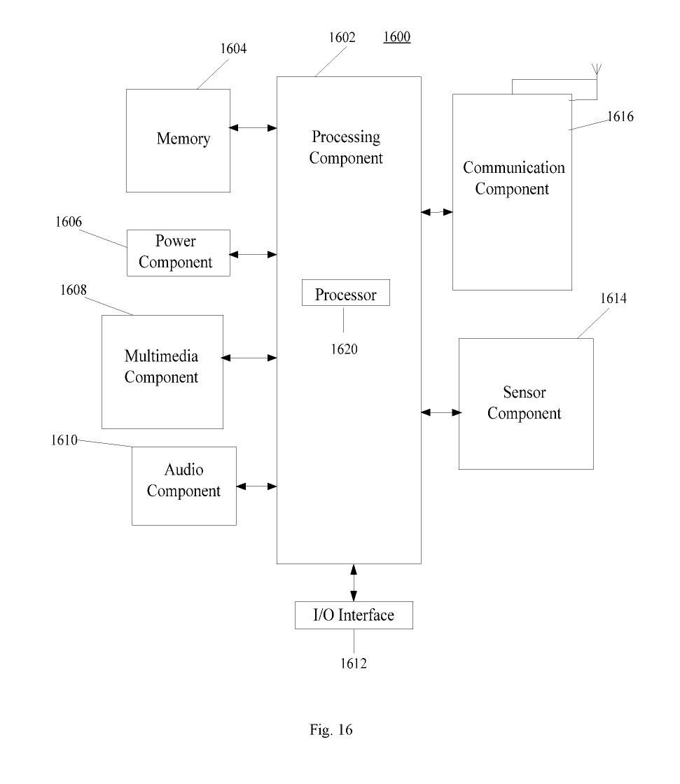

FIG. 16 is a block diagram of a user terminal 1600 for capturing a video frame according to an exemplary embodiment. For example, the user terminal 1600 may be a mobile phone, a computer, a digital broadcast terminal, a messaging device, a gaming console, a tablet, a medical device, exercise equipment, a personal digital assistant, an intelligent camera device, an intelligent camera, and the like.

Referring to FIG. 16, the user terminal 1600 may include one or more of the following components: a processing component 1602, a memory 1604, a power component 1606, a multimedia component 1608, an audio component 1610, an input/output (I/O) interface 1612, a sensor component 1614, and a communication component 1616.

The processing component 1602 typically controls overall operations of the user terminal 1600, such as the operations associated with display, telephone calls, data communications, camera operations, and recording operations. The processing component 1602 may include one or more processors 1620 to execute instructions to perform all or part of the steps in the above described methods. Moreover, the processing component 1602 may include one or more modules which facilitate the interaction between the processing component 1602 and other components. For instance, the processing component 1602 may include a multimedia module to facilitate the interaction between the multimedia component 908 and the processing component 1602.

The memory 1604 is configured to store various types of data to support the operation of the user terminal 1600. Examples of such data include instructions for any applications or methods operated on the device 1600, contact data, phonebook data, messages, pictures, video, etc. The memory 1604 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 1606 provides power to various components of the user terminal 1600. The power component 1606 may include a power management system, one or more power sources, and any other components associated with the generation, management, and distribution of power in the user terminal 1600.

The multimedia component 1608 includes a screen providing an output interface between the user terminal 1600 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 1608 includes a front camera and/or a rear camera. The front camera and the rear camera may receive an external multimedia datum while the user terminal 1600 is in an operation mode, such as a photographing mode or a video mode. Each of the front camera and the rear camera may be a fixed optical lens system or have focus and optical zoom capability.

The audio component 1610 is configured to output and/or input audio signals. For example, the audio component 1610 includes a microphone (“MIC”) configured to receive an external audio signal when the user terminal 1600 is in an operation mode, such as a call mode, a recording mode, and a voice recognition mode. The received audio signal may be further stored in the memory 1604 or transmitted via the communication component 1616. In some embodiments, the audio component 1610 further includes a speaker to output audio signals.

The I/O interface 1612 provides an interface between the processing component 1602 and peripheral interface modules, such as a keyboard, a click wheel, buttons, and the like. The buttons may include, but are not limited to, a home button, a volume button, a starting button, and a locking button.

The sensor component 1614 includes one or more sensors to provide status assessments of various aspects of the user terminal 1600. For instance, the sensor component 1614 may detect an open/closed status of the user terminal 1600, relative positioning of components, e.g., the display and the keypad, of the user terminal 1600, a change in position of the user terminal 1600 or a component of the user terminal 1600, a presence or absence of user contact with the user terminal 1600, an orientation or an acceleration/deceleration of the user terminal 1600, and a change in temperature of the user terminal 1600. The sensor component 1614 may include a proximity sensor configured to detect the presence of nearby objects without any physical contact. The sensor component 1614 may also include a light sensor, such as a CMOS or CCD image sensor, for use in imaging applications. In some embodiments, the sensor component 1614 may also include an accelerometer sensor, a gyroscope sensor, a magnetic sensor, a pressure sensor, or a temperature sensor.

The communication component 1616 is configured to facilitate communication, wired or wirelessly, between the user terminal 1600 and other devices. The user terminal 1600 can access a wireless network based on a communication standard, such as WiFi, 2G, or 3G, or a combination thereof. In one exemplary embodiment, the communication component 1616 receives a broadcast signal or broadcast associated information from an external broadcast management system via a broadcast channel. In one exemplary embodiment, the communication component 1616 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the user terminal 1600 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In exemplary embodiments, there is also provided a non-transitory computer-readable storage medium including instructions, such as included in the memory 1604, executable by the processor 1620 in the user terminal 1600, for performing the above-described methods. For example, the non-transitory computer-readable storage medium may be a ROM, a RAM, a CD-ROM, a magnetic tape, a floppy disc, an optical data storage device, and the like.

Other embodiments of the invention will be apparent to those skilled in the art from consideration of the specification and practice of the disclosure disclosed here. This application is intended to cover any variations, uses, or adaptations of the disclosure following the general principles thereof and including such departures from the present disclosure as come within known or customary practice in the art. It is intended that the specification and examples be considered as exemplary only, with a true scope and spirit of the invention being indicated by the following claims.

It will be appreciated that the present disclosure is not limited to the exact construction that has been described above and illustrated in the accompanying drawings, and that various modifications and changes can be made without departing from the scope thereof. It is intended that the scope of the invention only be limited by the appended claims.

What is claimed is:

1. A method for capturing a video frame in a user terminal, comprising:
receiving a first user operation for capturing a video frame in a video content displayed on the user terminal;
generating a first request according to the first user operation, wherein the first request comprises a time stamp and is configured to request an image or a video corresponding to the time stamp from a photographic device generating the video content;
sending the first request to the photographic device; and
obtaining the image or the video corresponding to the time stamp from the photographic device, wherein a resolution of the image or the video corresponding to the time stamp is higher than a resolution of the video content displayed on the user terminal.

2. The method according to claim 1, before receiving the first user operation, further comprising:
establishing a communication connection with the photographic device;
selecting a resolution for a video content to be displayed, wherein the selected resolution is lower than a resolution of a source video content photographed by the photographic device;
generating a second request, wherein the second request comprises the selected resolution and is configured to request the video content corresponding to the selected resolution from the photographic device;
sending the second request to the photographic device;
obtaining the video content corresponding to the selected resolution from the photographic device; and
displaying the video content.

3. The method according to claim 2, wherein the resolution for the video content to be displayed is selected based on a second user operation or a communication mode of the user terminal.

4. The method according to claim 1, wherein obtaining the image or the video corresponding to the time stamp from the photographic device comprises:
sending an address to the photographic device, such that the photographic device uploads the image or the video to the address;
receiving, from the photographic device, a message indicating that the image or the video is successfully uploaded; and
obtaining the image or the video from the address.

5. The method according to claim 1, wherein obtaining the image or the video corresponding to the time stamp from the photographic device comprises:
receiving, from the photographic device, a message indicating that the image or the video is successfully uploaded and an address indicating a position of the image or the video uploaded by the photographic device; and
obtaining the image or the video from the address.

6. A user terminal, comprising:
a processor;
a memory for storing instructions executable by the processor;
wherein the processor is configured to:
receive a first user operation for capturing a video frame in a video content displayed on the user terminal;
generate a first request according to the first user operation, wherein the first request comprises a time stamp and is configured to request an image or a video corresponding to the time stamp from a photographic device generating the video content;
send the first request to the photographic device; and
obtain the image or the video corresponding to the time stamp from the photographic device, wherein a resolution of the image or the video corresponding to the time stamp is higher than a resolution of the video content displayed on the user terminal.

7. The user terminal according to claim 6, wherein the processor is further configured to:
establish a communication connection with the photographic device;
select a resolution for a video content to be displayed, wherein the selected resolution is lower than a resolution of a source video content photographed by the photographic device;
generate a second request, wherein the second request comprises the selected resolution and is configured to request the video content corresponding to the selected resolution from the photographic device;
send the second request to the photographic device;
obtain the video content corresponding to the selected resolution from the photographic device; and
display the video content.

8. The user terminal according to claim 7, wherein the resolution for the video content to be displayed is selected based on a second user operation or a communication mode of the user terminal.

9. The user terminal according to claim 6, wherein the processor is configured to obtain the image or the video corresponding to the time stamp from the photographic device by steps of:
sending an address to the photographic device, such that the photographic device uploads the image or the video to the address;
receiving, from the photographic device, a message indicating that the image or the video content is successfully uploaded; and
obtaining the image or the video from the address.

10. The user terminal according to claim 6, wherein the processor is configured to obtain the image or the video corresponding to the time stamp from the photographic device by steps of:
receiving, from the photographic device, a message indicating that the image or the video is successfully uploaded and an address indicating a position of the image or the video uploaded by the photographic device; and
obtaining the image or the video from the address.

11. A photographic device, comprising:
a processor;
a memory for storing instructions executable by the processor;
wherein the processor is configured to:
receive a first request from a user terminal displaying a video content, wherein the first request comprises a time stamp and is configured to request an image or a video corresponding to the time stamp from the photographic device generating the video content;
extract the image or the video corresponding to the time stamp; and
provide the image or the video corresponding to the time stamp to the user terminal, wherein a resolution of the image or the video corresponding to the time stamp is higher than a resolution of the video content displayed on the user terminal.

12. The photographic device according to claim 11, wherein the processor is further configured to:
establish a communication connection with the user terminal;
receive a second request from the user terminal, wherein the second request comprises a resolution selected by the user terminal and is configured to request the video content corresponding to the selected resolution from the photographic device, and the selected resolution is lower than a resolution of a source video content photographed by the photographic device; and
provide the video content corresponding to the selected resolution to the user terminal.

13. The photographic device according to claim 12, wherein the processor is configured to provide the video content corresponding to the selected resolution to the user terminal by steps of:
converting the resolution of the source video content photographed by the photographic device so as to conform to the selected resolution; and
providing the video content corresponding to the selected resolution to the user terminal.

14. The photographic device according to claim 12, wherein the processor is configured to provide the image or the video corresponding to the time stamp to the user terminal by steps of:
receiving an address from the user terminal;
uploading the image or the video corresponding to the time stamp to the address; and
sending a message indicating that the image or the video is successfully uploaded to the user terminal.

15. The photographic device according to claim 12, wherein the processor is configured to provide the image or the video corresponding to the time stamp to the user terminal by steps of:
uploading the image or the video corresponding to the time stamp to an address indicating a position of the image or the video uploaded by the photographic device; and
sending a message indicating that the image or the video is successfully uploaded and the address to the user terminal.
